(19) United States
(12) Patent Application Publication
(10) Pub. No.: US 2025/0074122 A1
(43) Pub. Date: Mar. 6, 2025

(54) ROLLER ASSIST AND LIFT FOR TIRE CHANGING MACHINE

(71) Applicant: The Coats Company, LLC, LaVergne, TN (US)

(72) Inventor: Andrew Freeman, Hermitage, TN (US)

(21) Appl. No.: 18/821,781

(22) Filed: Aug. 30, 2024

Related U.S. Application Data
(60) Provisional application No. 63/579,712, filed on Aug. 30, 2023.

(51) Int. Cl. B60C 25/05

(52) U.S. Cl. CPC B60C 25/0545; B60C 25/0518; B60C 25/0521

(57) ABSTRACT

A tire changing machine includes a frame, a rotatable turntable for holding a wheel assembly, a bead breaker assembly engaging the wheel assembly, and a lifting assembly movably attached to the frame. The lifting assembly comprises a lift, a support platform connected to the lift, and a roller assembly movably linked to the support platform. The machine facilitates efficient tire changing operations by providing a stable platform for wheel manipulation and lifting mechanisms for easy access to the wheel assembly, enhancing the overall tire changing process.

### CROSS-REFERENCES TO RELATED APPLICATIONS

This application claims the benefit of U.S. Provisional Patent Application No. 63/579,712, filed Aug. 30, 2023.

### FIELD OF THE DISCLOSURE

The present disclosure relates generally to tire changers, and more particularly, to an improved roller assist and tire lift for a tire changing machine and a method of operation thereof.

### BACKGROUND

Various tire changing machines have been developed to facilitate the removal and installation of tires on wheel assemblies. Conventional tire changing machines typically consist of a frame supporting a rotatable turntable designed to secure the wheel assembly during the tire changing process. These machines often include a bead breaker assembly attached to the frame, which is responsible for separating the tire bead from the wheel rim. The bead breaker assembly is essential for ensuring efficient and safe tire changing operations by applying the necessary force to detach the tire bead from the rim.

The typical tire-changing procedure involves several steps: (1) loosening the seal between the tire's bead and the rim, (2) placing the tire-rim assembly on a rotatable table of a tire changer, (3) securing the rim to the table, (4) removing the tire from the rim using a mount/dismount head, (5) placing a new tire over the rim, (6) mounting the tire on the rim using the mount/dismount head to force the bead over the rim, and (7) filling the air chamber of the tire with air to inflate the new tire.

Tire changers typically require a lift system, which is a crucial component that facilitates the proper positioning of tires and wheels during the tire replacement process. The lift system in a tire changing machine serves multiple purposes, contributing to the overall efficiency and accuracy of the tire replacement process. The system elevates the vehicle's wheel to a comfortable working height for the technician. This ergonomic positioning reduces strain and enhances the technician's ability to access the tire and rim assembly.

Known tire changing machines incorporate various types of lift systems, each designed to cater to different vehicle sizes, tire complexities, and operational preferences. FIGS. 1 and 3 depict wheel lifts of tire changers of the prior art. Current wheel lifts 100 for tire changers are either placed at the point of use on machines with a bead loosener mechanism 102 (FIG. 1) or placed on the front/opposite side 104 of the tire changer due to space constraints (FIG. 3). On tire changers with the lift on the opposite side, the wheel assembly must be moved manually from the bead loosening side around to the lift.

Some machines, like the Coats Company Point of Use lift 106 (FIG. 2), are low profile and placed where the bead loosening occurs. This allows the wheel assembly to be lifted into the changing position on the tire changer immediately after the beads are loosened, improving efficiency and reducing the manual handling of the tire assembly.

Other known prior art tire lifts (FIG. 4) have assist rollers 108 attached to the machine in a fixed position, for assisting in “clocking” or rotating the wheel/tire assembly during the bead loosening process. The assist rollers are fixed to the tire changer, allowing the technician to push the wheel assembly against the rollers and rotate the wheel assembly with less effort and more speed. Without this device, the technician would have to lift the full weight of the tire off the ground and rotate the wheel assembly to the next bead loosening position.

Despite these advancements in tire changing machine technology, challenges persist in achieving optimal efficiency, ease of use, and safety during tire changing operations. While prior tire changing machines have focused on enhancing specific components, such as the bead breaker assembly or the lifting mechanism, these approaches have not provided a comprehensive solution that integrates the lift mechanism with a roller assist system as described in the present disclosure. This invention addresses the need for an improved tire changing machine that offers enhanced lifting capabilities and more efficient handling of wheel assemblies through an integrated roller assist system.

### BRIEF SUMMARY

The current disclosure provides an enhancement to conventional systems, at least in part by introducing a novel tire changing machine with a tire lift and roller assist and a method of operation thereof.

In some aspects, the techniques described herein relate to a tire changing machine, including: a frame; a rotatable turntable configured to retain a wheel assembly; a bead breaker assembly attached to the frame and configured to engage the wheel assembly; and a lifting assembly movably attached to the frame and configured to raise the wheel assembly, the lifting assembly further including; a lift; a support platform coupled to the lift; and a roller assembly movably coupled to the support platform.

In some aspects, the techniques described herein relate to a tire changing machine, wherein: the support platform further includes a top surface opening at the roller assembly; the roller assembly is movable between a deployed position and an inactive position; and the roller assembly, in the deployed position, protrudes at least in part through the top surface opening.

In some aspects, the techniques described herein relate to a tire changing machine, wherein: the roller assembly, in the inactive position, does not protrude through the top surface opening.

In some aspects, the techniques described herein relate to a tire changing machine, wherein: the lifting assembly is movable between a lowered position and a raised position; the roller assembly is in a deployed position when the lifting assembly is in the lowered position; and the roller assembly is in an inactive position when the lifting assembly is in the raised position.

In some aspects, the techniques described herein relate to a tire changing machine, wherein: the roller assembly further includes: a roller configured to engage a tire surface of the wheel assembly; and a base configured to support the roller when the roller is engaged to the tire surface.

In some aspects, the techniques described herein relate to a tire changing machine, wherein: the lifting assembly is movable between a lowered position and a raised position; the roller assembly is movable between a deployed position and an inactive position; the roller assembly is in the deployed position when the lifting assembly is in the lowered position; and the roller assembly is in the inactive position when the lifting assembly is in the raised position.

In some aspects, the techniques described herein relate to a tire changing machine, wherein: the support platform further includes a top surface opening at the roller assembly; and when the roller assembly is in the deployed position, the roller protrudes at least in part through the top surface opening and the base is configured to engage a ground surface.

In some aspects, the techniques described herein relate to a tire changing machine, wherein: the support platform further includes a top surface opening at the roller assembly; and when the roller assembly is in the inactive position, the roller does not protrude through the top surface opening.

In some aspects, the techniques described herein relate to a tire changing machine, wherein: the support platform further includes a sloped surface configured to engage a tire surface of the wheel assembly.

In some aspects, the techniques described herein relate to a tire changing machine, wherein: the lifting assembly is attached to the frame within an operational range of the bead breaker assembly.

In some aspects, the techniques described herein relate to a tire changing machine, wherein: the roller assembly is rotatably coupled to the support platform.

In some aspects, the techniques described herein relate to a tire changing machine, wherein: the base further includes a wheel, a shock absorbing material, or both.

In some aspects, the techniques described herein relate to a method of operating a tire changing machine, including: providing the tire changing machine, including: a frame; a rotatable turntable configured to retain a wheel assembly; a bead breaker assembly attached to a side of the frame and configured to engage the wheel assembly; and a lifting assembly movably attached to the frame and configured to raise the wheel assembly, the lifting assembly including: a support platform; and a roller assembly coupled to the support platform; loading the wheel assembly onto the support platform of the lifting assembly provided in a lowered position; separating, with the bead breaker assembly, a tire bead of the wheel assembly from a rim of the wheel assembly; raising the lifting assembly from the lowered position to a raised position; transferring the wheel assembly from the lifting assembly in the raised position to the rotatable turntable; and removing, at the rotatable turntable, a tire of the wheel assembly from the rim of the wheel assembly.

In some aspects, the techniques described herein relate to a method, wherein loading the wheel assembly onto the support platform further includes: rolling the wheel assembly onto the support platform via a sloped surface of the support platform; and engaging the roller assembly with the wheel assembly.

In some aspects, the techniques described herein relate to a method, wherein separating the tire bead of the wheel assembly from the rim of the wheel assembly further includes: rotatably engaging the wheel assembly against the roller assembly.

In some aspects, the techniques described herein relate to a method, wherein loading the wheel assembly onto the support platform of the lifting assembly provided in the lowered position further includes: contacting a ground surface with a base of the support platform; wherein a roller of the roller assembly protrudes at least in part through a top surface opening of the support platform.

In some aspects, the techniques described herein relate to a method, wherein: when raising the lifting assembly from the lowered position to the raised position, the roller retracts through the top surface opening and does not protrude through the top surface opening.

In some aspects, the techniques described herein relate to a method, wherein: the roller and the base rotate about a roller assembly axis, the roller assembly axis being parallel to a longitudinal axis of the roller.

In some aspects, the techniques described herein relate to a method, wherein: the roller and the base translate relative to the support platform.

In some aspects, the techniques described herein relate to a method, wherein: engaging the roller assembly with the wheel assembly causes the roller assembly to contact an edge of a top surface opening.

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 illustrates a prior art tire changing apparatus with a wheel lift disposed at the point of use with a bead loosener mechanism.

FIG. 2 illustrates a prior art tire changing apparatus with a low profile wheel lift.

FIG. 3 illustrates a prior art tire changing apparatus with a wheel lift disposed on a side of the tire changing apparatus opposite a bead loosener mechanism.

FIG. 4 illustrates a prior art tire changing apparatus with an assist roller.

FIG. 5 depicts an aspect of a tire changing machine according to the present disclosure.

FIG. 6 depicts an aspect of a lifting assembly according to the present disclosure.

FIG. 7 depicts an aspect of a roller assembly according to the present disclosure.

FIG. 8 depicts an aspect of the lifting assembly in the raised position according to the present disclosure.

FIG. 9A depicts an exemplary aspect of the support platform and roller assembly according to the present disclosure.

FIG. 9B depicts an exemplary aspect of the roller assembly rotatably movably coupled to the support platform.

FIG. 9C depicts an exemplary aspect of the roller assembly translationally movably coupled to the support platform.

FIG. 10 depicts an exemplary aspect of the method of operating the tire changing machine according to present disclosure.

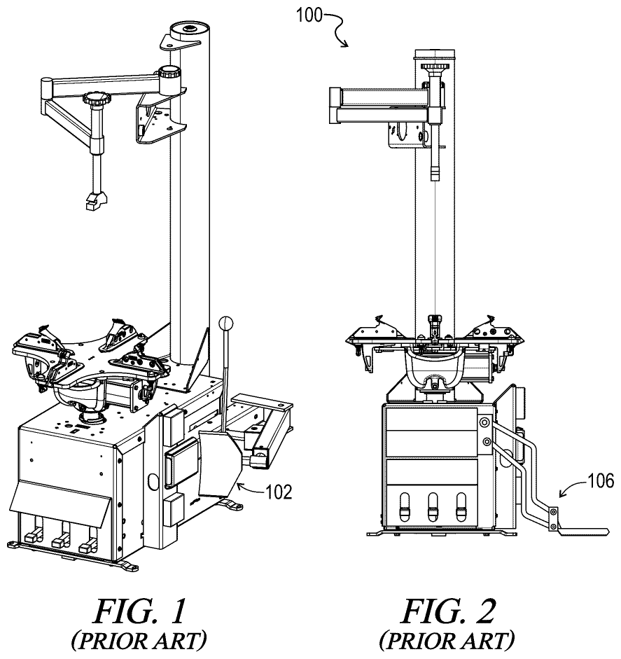

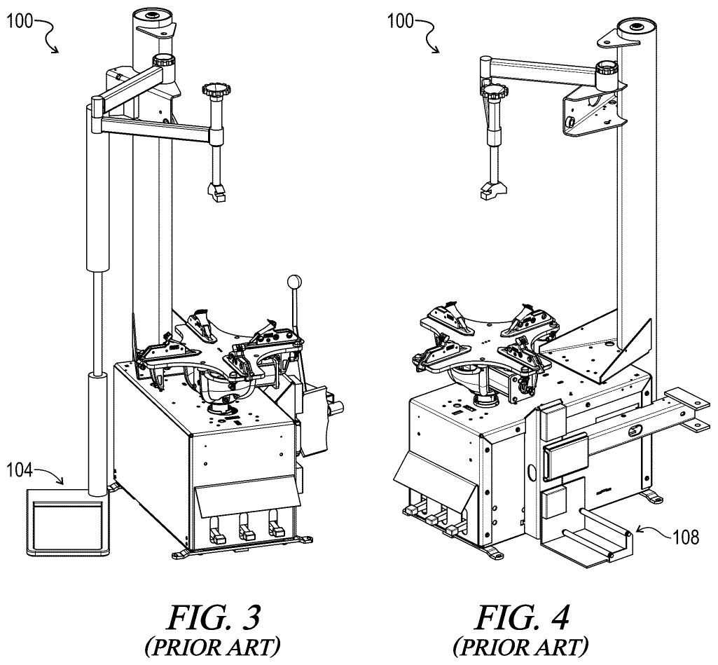

### DETAILED DESCRIPTION

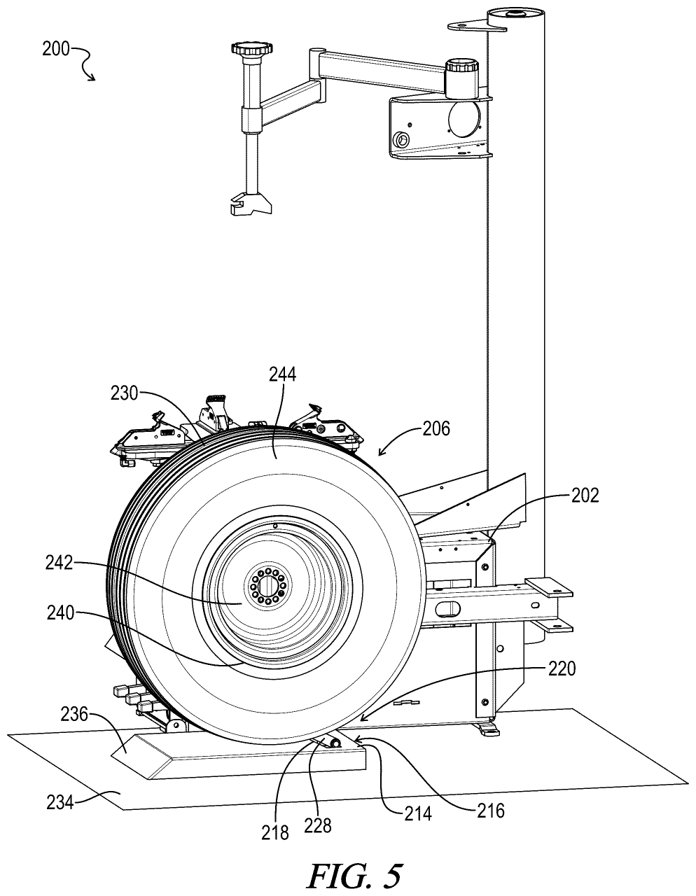

Referring now to FIGS. 5-10, various embodiments may now be described of a tire changing machine with a tire lift and roller assist and a method of operation thereof.

FIG. 5 depicts an aspect of a tire changing machine 200 according to the present disclosure. The tire changing machine 200 includes a frame 202 that may define a system of support elements and accessories to provide the structure associated with the tire changing machine 200. The frame 202 may include various surfaces, features, and functionalities as described further herein.

In some aspects, the tire changing machine 200 may include a turntable 204 to provide for a rotatable mounting structure of a wheel assembly 206. The turntable 204 may be configured to retain the wheel assembly 206 and provide a secure and rotatable mounting. The turntable 204 may be utilized to allow for easier removal of a tire 244 from a rim 242 and installation of a new tire on the rim 242. The tire changing machine 200 may further include known structures associated with the turntable 204 to aid in the use of the turntable 204, including mounting and demounting heads (not shown), which may aid in removing the tire 244 from the rim 242 and adding the new tire to the rim 242. In an exemplary aspect, the turntable 204 may be provided on a top surface of the frame 202, or may be generally disposed on an upper surface or top portion of the frame 202. The turntable 204 may be provided on any suitable location of the frame 202 of the tire changing machine 200, including being centrally located within the horizontal bounds of the frame 202 for each of access and workability and being disposed at a working height that is ergonomically beneficial to an operator. In some aspects, the turntable 204 may be coupled to the frame 202 in various proximities of other working components of the tire changing machine 200 as described further herein.

In some aspects, the tire changing machine 200 may further include a bead breaker assembly 208. The bead breaker assembly 208 may be configured to engage the wheel assembly 206 and used to separate a tire bead 240 of the wheel assembly 206 from the rim 242 of the wheel assembly 206. The bead breaker assembly 208 may be provided as an assembly of components that together form the bead breaker, including a bead breaker arm, a pressure pad or shoe, an activation mechanism, and control pedals or buttons. The bead breaker arm may provide an arm or lever attached to the frame 202 of the tire changing machine 200 and may be position to apply directly to the sidewall of the tire 244 near the tire bead 240 of the wheel assembly 206. The pressure pad or shoe may be provided as a flat or slightly curved metal pad at the terminus of the bead breaker arm and which makes contact with the tire 244. The pressure pad or show may be designed to fit against a sidewall of the tire 244 and the tire bead 240 without causing damage to the tire 244 during a bead breaking process. The activation mechanism may be provided as a manual (e.g., lever-operated) or powered (e.g., hydraulic or pneumatic) options to control the movement of the bead breaker arm, allowing the same to provide pressure to the tire bead. The control pedals and buttons may facilitate application of pressure and provide a hands-free operation of the bead breaker assembly.

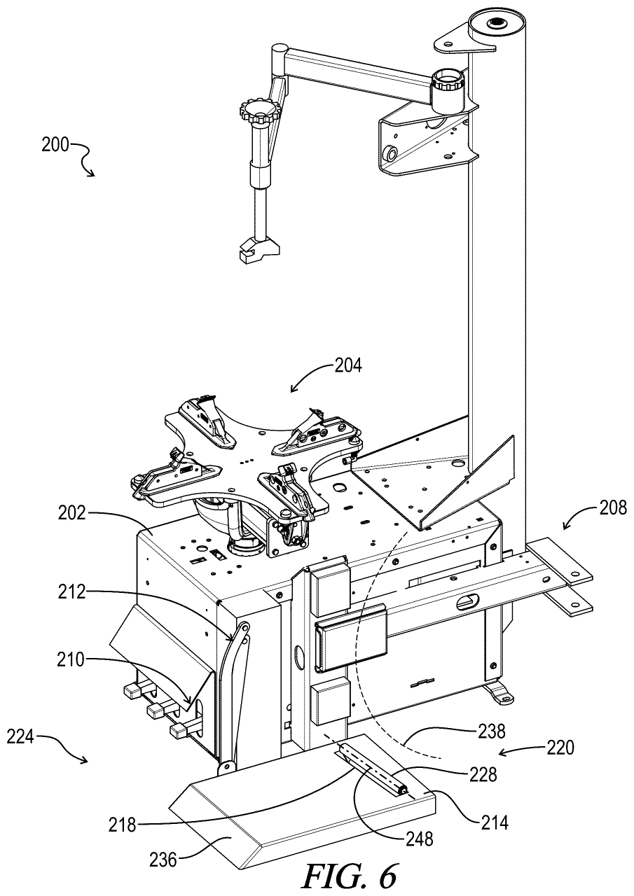

FIG. 6 depicts an aspect of a lifting assembly 210 according to the present disclosure. The tire changing machine 200 includes a lifting assembly 210 attached to the frame 202. The lifting assembly 210 is attached to the frame 202 in a movable arrangement such that various components of the lifting assembly 210 may be movable relative to the frame 202 of the tire changing machine 200. The movable nature of the lifting assembly 210 may be based at least in part on the components utilized to form the lifting assembly 210, including a lift 212 of the lifting assembly 210. The lift 212 may provide components and action operably disposed between a support platform 214 and associated components of the tire changing machine 200, including the turntable 204, bead breaker assembly 208, and a ground surface 234.

In some aspects, the lifting assembly 210 may included manual lift mechanisms, hydraulic mechanisms, pneumatic mechanisms, electric mechanisms, integrated systems, fixed position systems, mobile platforms, scissor lift type, telescopic lift type, or a combination thereof. A person of ordinary skill in the art may appreciate a lifting assembly distinct from the exemplary structures and functions described herein but nonetheless configured to raise the support platform and loaded wheel assembly from a ground, roller, or otherwise supporting surface. Wheel lift or hoist mechanisms in tire changing machines can be broadly categorized into manual, hydraulic, pneumatic, and electric types, each utilizing a wheel platform to assist in lifting heavy wheel assemblies. Manual lifts rely on physical effort, while hydraulic and pneumatic lifts use fluid pressure or compressed air, respectively, to provide smooth, controlled lifting with minimal exertion. Electric lifts offer precise control and ease of use, ideal for high-volume operations. Integrated lift systems, often found in advanced tire changers, seamlessly combine lifting with other machine functions, enhancing efficiency.

In various aspects, lifts can be either fixed or mobile, depending on the design. Fixed position platforms provide stability, particularly for large tires, while mobile platforms offer flexibility in positioning around the tire changer. Scissor and telescopic lift designs further enhance versatility by offering compact or extended lifting capabilities, catering to various tire sizes and shop environments. Each type of lift is designed to improve the tire changing process by reducing physical strain and increasing operational efficiency.

In some aspects, the lifting assembly 210 may be provided as a manual lifting assembly. In some aspects, the manual lifting assembly may include manual action associated specifically with the lifting of the tire and lifting platform. In some aspects, the manual lifting assembly may include manual action associated with rolling the wheel assembly 206 onto the support platform 214. In some aspects, manual rolling of the wheel assembly 206 onto the support platform 214 may be provided as an aspect of any of the lifting assembly 210 associated with the tire changing machine 200.

In some aspects, the lifting assembly 210 may raise the wheel assembly 206 from a ground surface, a roller surface, or an otherwise supporting surface to an operating component of the tire changing machine 200, including the turntable 204, the bead breaker assembly 208, the lifting assembly 210, or any other recognizable operable components associated with a lifting of the wheel assembly 206 to an action component of the tire changing machine 200. In exemplary aspects, the lifting assembly 210 may raise the wheel assembly 206 from a lowered position 224 to a raised position 226. The movement of the support platform 214 from the lowered position 224 to the raised position 226 may provide a raising 308 of the lifting assembly 210 within an aspect of the current disclosure. The raising 308 of the lifting assembly 210 may similarly be accomplished by an incremental bead breaker assembly 208 of the lifting assembly 210 from the lowered position 224 but not completely to the raised position 226. In some aspects, the raised position 226 may be determined by whether the lifting assembly 210 is in a position sufficient to cause a roller assembly 216 to move from a deployed position 220 to an inactive position 222 as discussed further herein. In further aspects, the lifting assembly 210 may raise from the lowered position 224 to the raised position 226 for the wheel assembly 206 and provide a measurement of the lowered position 224 and raised position 226 for analysis and review.

In some aspects, the lifting assembly 210 may include a support platform 214 configured to support the wheel assembly 206 being worked upon. The support platform 214 may be configured to support the wheel assembly 206 from the lowered position 224 to the raised position 226. In some aspects, the support platform 214 may be configured to be loaded with the wheel assembly 206 as described further herein, including by a step of rolling 316 the wheel assembly 206 onto the support platform 214. The support platform 214 may be provided as a generally horizontal surface on which to rest the wheel assembly 206. In some aspects, the support platform 214 may be provided in a substantially rectangular shape, with a long side disposed parallel to a side of the frame 202 and the short side disposed parallel to a front surface of the frame 202. The support platform 214 may be provided in other shapes contemplated for use to support the wheel assembly 206.

In some aspects, the support platform 214 may include a sloped surface 236 configured to engage the tire surface 230 of the 206. The sloped surface 236 may provide a structure otherwise associated with a ramp and may ease the step of loading 304 the wheel assembly 206 onto the support platform 214. In an exemplary aspect, the sloped surface 236 may form one of the short sides of a generally rectangular support platform 214 and may be positioned to receive a rolling wheel assembly 206. In some aspects, the sloped surface 236 may be disposed at a portion of the support platform 214 and may serve to transition the wheel assembly 206 from the ground surface 234 or other supporting surface onto a top surface of the support platform 214 provided generally parallel to the ground surface 234. In some aspects, the ground surface 234 may occupy a majority of the top surface of the support platform 214, and may include the top surface opening 218 provided on the sloped surface 236.

In some aspects, the support platform 214 may be coupled to the lift 212. In an exemplary aspect, the lift 212 may be provided as one or more lifting arms, and may together with the coupled support platform 214, form a four-bar linkage for maintaining the support platform 214 in a horizontal position parallel to a ground surface 234 when raising 308 the support platform 214 from the lowered position 224 to the raised position 226. Other coupling arrangements between the support platform 214 and the lift 212 may be contemplated based on the various mechanisms capable of being implemented as the lift 212 as described herein.

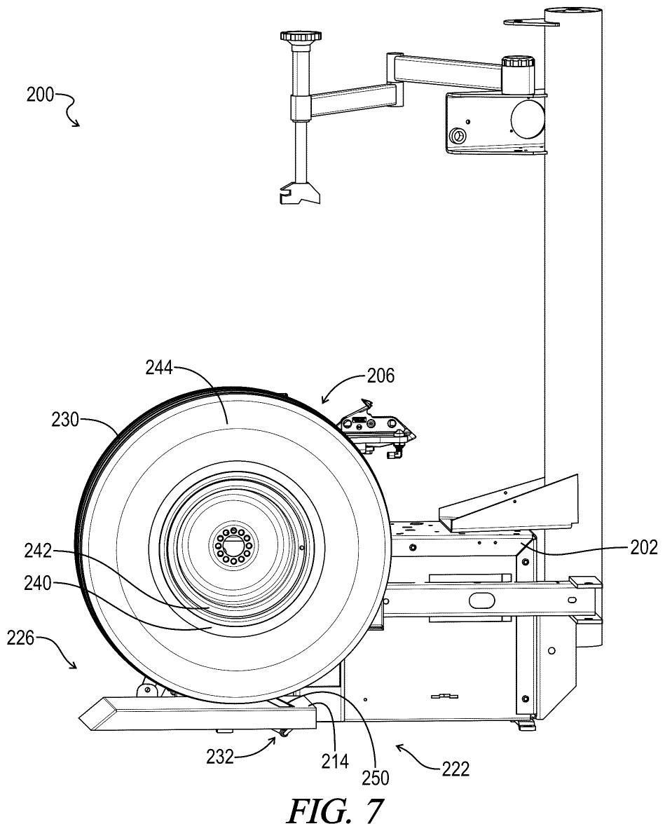

FIG. 7 depicts an aspect of a roller assembly 216 according to the present disclosure. In some aspects, the lifting assembly 210 may include a roller assembly 216 movably coupled to the support platform 214. The roller assembly 216 may be movably coupled to the support platform 214 such that the roller assembly 216 is configured to change positions, location, operation, function, or a combination thereof relative to the position, location, operation, or function of the support platform 214. In an exemplary aspect, the roller assembly 216 may be movably coupled to the support platform 214 such that the roller assembly 216 is movable between a deployed position 220 and an inactive position 222. The roller assembly 216 may be movably coupled to the support platform 214 in various suitable manners and may allow for multiple or alternative ranges of motion of the roller assembly 216 relative to the support platform 214.

In some aspects, the roller assembly 216 may include a manual roller assembly. The manual roller assembly may provide a smooth rolling surface to assist in minimizing friction between the tire surface 230 and the support platform 214. During use, an operator may press the wheel assembly 206 against the roller assembly 216, particularly a roller 228 thereof, to rotate the wheel assembly 206, allowing the bead breaker assembly 208 to engage portions of the tire bead 240 spanning the entire circumference of the rim 242.

In some aspects, the roller assembly 216 may include a power-assisted roller assembly. The power-assisted roller assembly may be operably coupled with a motor or pneumatic system that provides power to the roller assembly 216 and actively rotates the roller 228, and thus the wheel assembly 206, during a bead breaking process. The power-assisted roller assembly may be actuated by a pedal, button, lever, or any suitable actuator. In some aspects, the actuator employed to control the operation of the power-assisted roller assembly is hands-free, allowing the operator to keep both hands on the wheel assembly 206 during the bead breaking process. The power-assisted roller assembly may provide consistent and controlled rotation force, allowing for smooth and uniform movement of the wheel assembly 206 during the bead breaking process. The power-assisted roller assembly may provide variable speeds of rotation to provide for precise positioning. In some aspects, the power-assisted roller assembly may provide selectable and controllable rotation in both speed, direction, and torque to allow for full configurability of rolling the wheel assembly 206 during the bead breaking process.

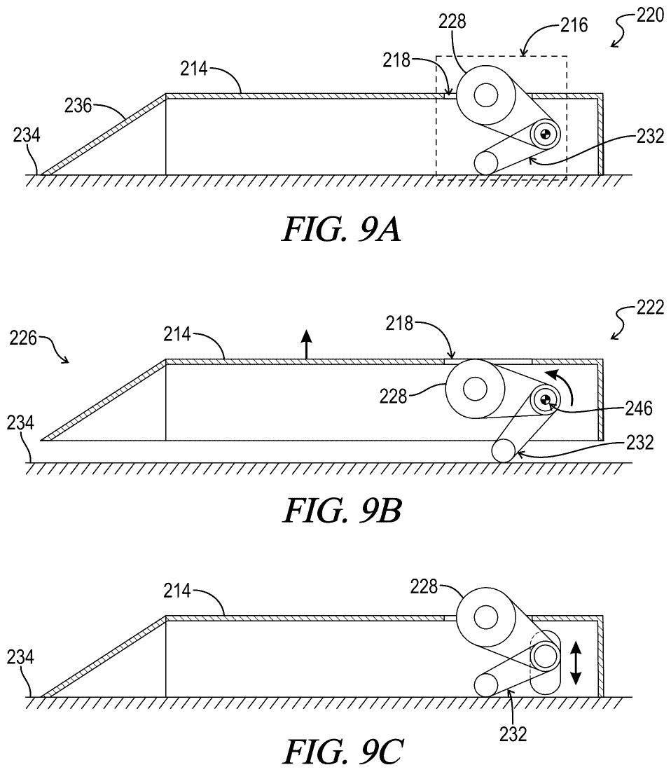

FIG. 9C depicts an exemplary aspect of the roller assembly 216 movable coupled to the support platform 214. In an exemplary aspect, the roller assembly 216 may be movably coupled to the roller assembly 216 such that the roller assembly 216 translates relative to the support platform 214. The direction of translation may be based on the nature of the coupling between the roller assembly 216 and the support platform 214, and in some aspects, may be vertical, horizontal, generally vertical, generally horizontal, or any direction allowing the roller assembly 216 to move between the deployed position 220 and the inactive position 222.

FIG. 9B depicts an exemplary aspect of the roller assembly 216 movably coupled to the support platform 214. In an exemplary aspect, the roller assembly 216 may be movably coupled to the roller assembly 216 such that the roller assembly 216 rotates about an axis of rotation and rotates relative to the support platform 214. In this aspect, the roller assembly 216 may be rotatably coupled to the support platform 214. The roller assembly 216, including the roller 228 and the base 232, may rotate about a roller assembly axis 246 defined as an axis running through a point of the roller assembly 216, and defined as being parallel to and separate and distinct from a longitudinal axis 248 of a roller 228 of the roller assembly 216. The roller assembly axis 246 and the longitudinal axis 248 of the roller 228 may be disposed with a distance between them to allow the roller 228 to rotate about the roller assembly axis 246. In some aspects, the roller assembly 216 may be rotatably coupled to the support platform 214 at the roller assembly axis 246 such that the roller 228 and the longitudinal axis 248 of the roller 228 rotate about the roller assembly axis 246.

In some aspects, the roller assembly 216 may include the roller 228 and the base 232. In some aspects, the roller assembly 216 may include one or more rollers 228. The roller assembly 216 with more than one roller 228 may provide a plurality of rollers 228 disposed at different locations, with each of the roller 228 of the plurality of rollers 228 configured to engage the tire surface 230 of the tire 244 during an operation of separating 306 the tire bead 240 from the rim 242 with the bead breaker assembly 208. In some aspects, the roller assembly 216 with more than one of the roller 228 may be provided as a fixed multi-roller assembly, an adjustable multi-roller assembly, or a hybrid roller assembly that combines fixed and adjustable roller 228. The fixed multi-roller assembly may provide a number of rollers fixed in position at the roller assembly 216 and aligned such that the positions of the roller 228 may accommodates the tire 244 of various sizes and shapes, thus providing consistent support among different types of tires. The adjustable multi-roller assembly may allow the operator to change the spacing, angle, and other positional relationships among the roller 228 to provide more customized fitting of tires of various sizes and shapes.

In an exemplary aspect, the roller assembly axis 246 may be parallel or substantially parallel to a short edge or side of the rectangular support platform 214. The orientation of the roller assembly axis 246 relative to the position and orientation of the support platform 214 may allow for the loading 304 of the wheel assembly 206 onto the support platform 214, including the rolling 316 of the wheel assembly 206 onto the support platform 214. In an exemplary aspect, an axis defining the rotation of the wheel assembly 206 may be parallel to the longitudinal axis 248 of the roller 228 when the wheel assembly 206 is loaded onto the support platform 214 and during a step of separating 306 the tire bead 240 from the rim 242 with the bead breaker assembly 208. In some aspects, the longitudinal axis 248 of the roller 228 and the roller assembly axis 246 may extend transverse to the direction in which the loading 304 of the wheel assembly 206 onto the support platform 214 occurs such that the wheel assembly 206 will abut the roller 228 when loaded onto the support platform 214.

In some aspects, the support platform 214 may further include a top surface opening 218. The top surface opening 218 may be provided on the top surface of the support platform 214 or on whichever surface of the support platform 214 that engages with and supports the wheel assembly 206 when the wheel assembly 206 is loaded onto the support platform 214. The top surface opening 218 is configured to allow the roller assembly 216 to move, at least in part, through the top surface opening 218. In some aspects, the deployed position 220 of the roller assembly 216 will provide the roller assembly 216 protruding, at least in part, through the top surface opening 218, and the inactive position 222 of the roller assembly 216 will provide the roller assembly 216 as not protruding through the top surface opening 218. The top surface opening 218 may allow for movement of the roller assembly 216 therethrough to the degrees of freedom of movement allowable from the movable coupling of the roller assembly 216 to the support platform 214. The top surface opening 218 may be provided at the location of the roller assembly 216 to allow for the movement of the roller assembly 216, at least in part, through the top surface opening 218. It will be understood that according to an aspect of the disclosure, protruding, in part or otherwise, through the top surface opening 218 defines a position of the roller assembly 216 such that at least a portion of the roller assembly 216 extends from one side of the top surface opening 218 to the other side.

In some aspects, the top surface opening 218 may be provided in a substantially rectangular shape, with a long side of the top surface opening 218 being parallel or substantially parallel to a short side of the support platform 214. The top surface opening 218 may allow for the roller assembly 216 to protrude, at least in part, through the top surface opening 218. In some aspects, the roller 228 of the roller assembly 216 may be the component of the roller assembly 216 that protrudes through the top surface opening 218. In some aspects, the roller assembly 216 may be movable between the deployed position 220 and the inactive position 222, with the deployed position 220 defining an arrangement of the roller assembly 216 protruding, at least in part, through the top surface opening 218. The inactive position 222 may define an arrangement of the roller assembly 216 not protruding through the top surface opening 218.

In some aspects, the deployed position 220 may define a position of the roller assembly 216 relative to the support platform 214 such that when the wheel assembly 206 is loaded onto the support platform 214, the tire surface 230 of the wheel assembly 206 may engage with the roller 228 of the roller assembly 216 when the roller assembly 216 is in the deployed position 220. In the deployed position 220, the roller assembly 216 may be arranged to engage with and support the wheel assembly 206 during a step of separating 306 the tire bead 240 from the rim 242 with the bead breaker assembly 208. In this manner, the roller assembly 216 may be arranged to provide load bearing support in the deployed position 220 to the extent to support, at least in part, the wheel assembly 206.

In an exemplary aspect, during the step of separating 306 the tire bead 240 from the rim 242 of the wheel assembly 206 with the bead breaker assembly 208, a user may enact a force on the wheel assembly 206 in a direction and magnitude against the roller 228 of the roller assembly 216 sufficient to reduce the effective normal force of the wheel assembly 206 on the support platform 214, convert that force to horizontal motion, reduce friction, and ease in the rotation of the wheel assembly 206 on the roller assembly 216. In this manner, the deployed position 220 of the roller assembly 216 in combination with the arrangement of the roller assembly 216 and the support platform 214 allow for enhanced “clocking” procedures when bead breaking. As will be recognized by persons of ordinary skill in the art, when the wheel assembly 206 is pressed against the roller 228, the roller 228 and the roller assembly 216 may support a portion of the weight of the wheel assembly 206, effectively reducing the vertical (downward) force the operator must overcome to rotate the wheel assembly 206. This may be provided by the roller 228 transferring some of the weight of the wheel assembly 206 into a horizontal force components, helping the wheel assembly 206 to pivot about the bead breaker assembly 208 and decreasing the friction between the tire 244 and the support platform 214.

In some aspects, the inactive position 222 may define a position of the roller assembly 216 relative to the support platform 214 such that when the wheel assembly 206 is loaded onto the support platform 214, the tire surface 230 of the wheel assembly 206 will not engage with the roller 228 of the roller assembly 216 when the roller assembly 216 is in the inactive position 222.

In some aspects, the position of the roller assembly 216 may be operably associated with the position of the lifting assembly 210, in particular, the position of the support platform 214. The lifting assembly 210 may be movable between a lowered position 224 and a raised position 226, including any position between the lowered position 224 and raised position 226. In the lowered position 224, the support platform 214 of the lifting assembly 210 may be in contact with the ground surface 234 or may be in immediate and close proximity with the ground surface 234 to facilitate loading 304 of the wheel assembly 206 on the support platform 214. In the raised position 226, the support platform 214 of the lifting assembly 210 may be raised or elevated from the ground surface 234. In an exemplary aspect, the raised position 226 of the lifting assembly 210 provides the support platform 214 at a raised position within a workable range of the turntable 204 so that a wheel assembly 206 loaded onto the support platform 214 may easily be transferred from the support platform 214 to the turntable 204.

In some aspects, when the lifting assembly 210 is provided in the lowered position 224, the roller assembly 216 may be provided in the deployed position 220. The roller assembly 216 in the deployed position 220 may include the roller 228 protruding, at least in part, through the top surface opening 218 and configured to engage the tire surface 230 of the wheel assembly 206 when the wheel assembly 206 is loaded onto the support platform 214.

In some aspects, the roller assembly 216 includes the roller 228 and a base 232. The roller 228 may be provided at an upper portion of the roller assembly 216 such that the roller 228 may protrude, at least in part, through the top surface opening 218. Other configurations of the roller assembly 216 may be contemplated based on the arrangement between the roller assembly 216 and the support platform 214. In an exemplary aspect, the roller 228 of the roller assembly 216 moves vertically to protrude through the top surface opening 218, whether the movement be rotational or translational. In other aspects, the roller 228 of the roller assembly 216 may move horizontally or any other direction to facilitate protruding, at least in part, through the top surface opening 218. In an exemplary aspect, the base 232 of the roller assembly 216 is configured to be in contact with the ground surface 234 when the lifting assembly 210 is in the lowered position 224. In this manner, the base 232 provides support for the roller assembly 216 and supports the roller assembly 216 in the deployed position 220, including when the roller assembly 216 engages with the wheel assembly 206.

In some aspects, the base 232 may support the roller assembly 216 and the roller 228 when the roller 228 engages the tire surface 230 as described in the “clocking” operation herein. The base 232 may thus function to aid in the separating 306 of the tire bead 240 from the rim 242 through the use of the bead breaker assembly 208.

In some aspects, the base 232 may include a wheel, a shock absorbing material, or both. In an exemplary aspect, the base 232 may be provided with a cross-beam supporting leg supports of the roller assembly 216, with wheels provided on the cross-beam. The wheels of the base 232 may allow the base 232 and the roller assembly 216 to rollingly engage the ground surface 234. In operation, the wheels may allow the roller assembly 216 to rotate about the roller assembly axis 246 as the support platform 214 of the lifting assembly 210 raises from the ground surface 234. The shock absorbing material of the base 232 may facilitate the load bearing support function of the base 232 in maintaining the deployed position 220 of the roller assembly 216 when the wheel assembly 206 engages with the roller assembly 216.

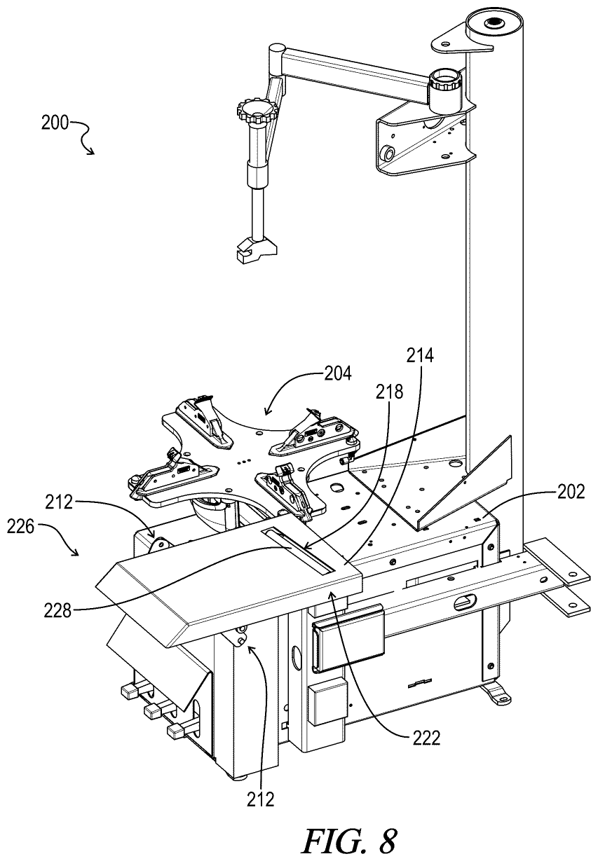

FIG. 8 depicts an aspect of the lifting assembly 210 in the raised position 226 according to the present disclosure. In some aspects, when the lifting assembly 210 is provided in the raised position 226, the roller assembly 216 may be provided in the inactive position 222. As the lifting assembly 210 raises from the lowered position 224, the roller assembly 216 may be removed from contact with the ground surface 234. As the roller assembly 216 is no longer in contact with the ground surface 234, the roller 228 may move relative to the support platform 214 and the top surface opening 218 to protrude progressively less through the top surface opening 218. Upon reaching a determinable height from the lowered position 224, the roller assembly 216 moves to the inactive position 222. In some aspects, the height at which the roller assembly 216 moves to the inactive position 222 may be less than the raised position 226 but greater than the lowered position 224. In some aspects, the raised position 226 may be the position of the lifting assembly 210 at which the roller assembly 216 moves to the inactive position 222.

In some aspects, the lifting assembly 210 may be attached and coupled to the frame 202 within an operational range 238 of the bead breaker assembly 208 such that when the wheel assembly 206 is loaded onto the support platform 214 of the lifting assembly 210, the bead breaker assembly 208 may engage with the wheel assembly 206 and provide the step of separating 306 the tire bead 240 from the rim 242. As described herein, the lifting assembly 210 may be provided in the lowered position 224 to allow for loading 304 of the wheel assembly 206 onto the support platform 214. Once the wheel assembly 206 is loaded onto the lifting assembly 210, the bead breaker assembly 208 may be used to separate the tire bead 240 from the rim 242 and thus, the bead breaker assembly 208 may be within an operation range of the lifting assembly 210 as the lifting assembly 210 is attached to the frame 202.

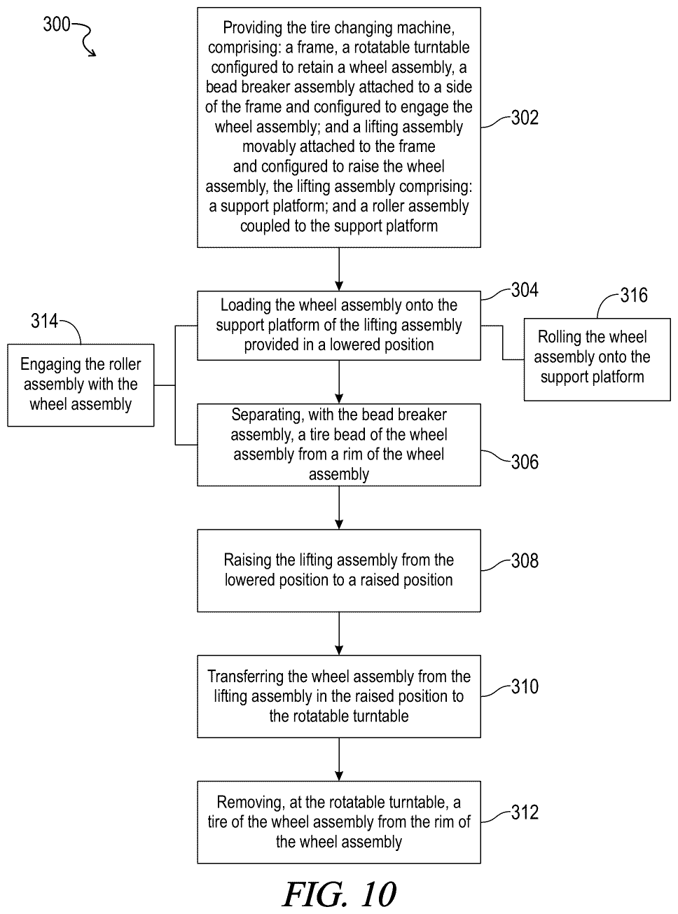

FIG. 10 depicts an exemplary aspect of the method of operating the tire changing machine according to present disclosure. In some aspects, a method 300 of operating the tire changing machine 200 may be performed. The method 300 may include first providing 302 the tire changing machine 200. In some aspects, providing 302 the tire changing machine 200 may include the tire changing machine 200 as described herein. The tire changing machine 200 may include the frame 202 the turntable 204 configured to retain the wheel assembly 206, the bead breaker assembly 208 attached to the side of the frame 202 and configured to engage the wheel assembly 206, and the lifting assembly 210, including the support platform 214 and the roller assembly 216 coupled to the support platform 214, movably attached to the frame 202 and configured to raise the wheel assembly 206.

In some aspects, the method 300 may further include a step of loading 304 the wheel assembly 206 onto the support platform 214 of the lifting assembly 210 when the lifting assembly 210 is provided in the lowered position 224. The operator may load the wheel assembly 206 from an existing supporting surface of the wheel assembly 206, including the ground surface 234, onto the support platform 214 by any suitable method. In an exemplary aspect, the step of loading 304 the wheel assembly 206 onto the support platform 214 includes rolling 316 the wheel assembly 206 onto the support platform 214. In some aspects, the sloped surface 236 of the support platform 214 may aid in loading 304 the wheel assembly 206 onto the support platform 214 by providing a transition surface from the ground surface 234 or other supporting surface onto the top surface of the support platform 214.

In some aspects, the step of loading 304 the wheel assembly 206 onto the support platform 214 of the lifting assembly 210 may further include engaging 314 the roller assembly 216 with the wheel assembly 206. The roller assembly 216 in the deployed position 220, when the lifting assembly 210 is in the lowered position 224, may provide a stopping surface for loading 304 the wheel assembly 206 onto the support platform 214 to halt further forward movement of the wheel assembly 206 past the support platform 214. Further, the roller assembly 216 may provide a rotatable engagement surface for the wheel assembly 206 to aid in the step of separating 306 the tire bead 240 from the rim 242 of the wheel assembly 206. In operation, the step of engaging 314 the roller assembly 216 with the wheel assembly 206 may enact a force on the roller assembly 216 and cause the roller assembly 216 to move slightly and abut a structure associated with the support platform 214 that will prevent further movement of the roller assembly 216 based upon forcible contact with the wheel assembly 206. In an exemplary aspect, the wheel assembly 206 may be loaded on the support platform 214 and may roll to engage with the roller assembly 216 and cause the roller assembly 216 to contact and abut an edge 250 of the top surface opening 218.

In some aspects, the method 300 may further include a step of separating 306 the tire bead 240 of the wheel assembly 206 from the rim 242 of the wheel assembly 206 through the use of the bead breaker assembly 208. A bead breaker arm and pressure pad or shoe coupled to the bead breaker arm may operate within range of the wheel assembly 206 loaded onto the support platform 214 of the lifting assembly 210. The operator may control the tire changing machine 200 to activate the bead breaker assembly 208 to first contact the wheel assembly 206 and initiate separation between the tire bead 240 and the rim 242. To facilitate an even separation of the tire bead 240 from the rim 242 and avoid damage to the wheel assembly 206, the operator may roll the wheel assembly 206 by action of the roller assembly 216 and may sequentially repeat the operation of separating 306 the tire bead 240 from the rim 242 at different location around the rim 242.

Once the tire bead 240 of the wheel assembly 206 has been separated from the rim 242, the method 300 may further include a step of raising 308 the lifting assembly 210 from the lowered position 224 to the raised position 226. As described herein, raising 308 the lifting assembly 210 from the lowered position 224 to the raised position 226 may be by action associated with the lift 212 and the associated structures providing the support platform 214 coupled to the lift 212.

The step of raising 308 the lifting assembly 210 from the lowered position 224 to the raised position 226 may include a step of the roller assembly 216 moving from the deployed position 220 to the inactive position 222. In some aspects, the roller assembly 216 moves from the deployed position 220 to the inactive position 222 at a height of the support platform 214 located between the lowered position 224 and the raised position 226. In some aspects, the roller assembly 216 moves from the deployed position 220 to the inactive position 222 at the raised position 226.

The method 300 may further include a step of transferring 310 the wheel assembly 206 from the lifting assembly 210 in the raised position 226 to the turntable 204. In the raised position 226 the roller assembly 216 is in the inactive position 222, and accordingly, there is not structure protruding through the top surface opening 218 to prevent the wheel assembly 206 from being transferred or rolled off the support platform 214 onto the turntable 204.

The method 300 may further include a step of removing 312 the tire 244 of the wheel assembly 206 from the rim 242 of the wheel assembly 206 by action associated with the turntable 204.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

In the context of this patent application, the use of the indefinite articles “a” or “an” should be interpreted to mean “at least one” or “one or more” unless explicitly stated otherwise to limit the quantity to a single item. This usage applies to all instances where these articles appear, and it should be understood that the presence of these terms does not restrict the scope of the invention to a singular embodiment, but rather encompasses multiple embodiments as may be appropriate.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

We claim:

1. A tire changing machine, comprising:
a frame;
a rotatable turntable configured to retain a wheel assembly;
a bead breaker assembly attached to the frame and configured to engage the wheel assembly; and
a lifting assembly movably attached to the frame and configured to raise the wheel assembly, the lifting assembly further comprising;
a lift;
a support platform coupled to the lift; and
a roller assembly movably coupled to the support platform.

2. The tire changing machine according to claim 1, wherein:
the support platform further comprises a top surface opening at the roller assembly;
the roller assembly is movable between a deployed position and an inactive position; and
the roller assembly, in the deployed position, protrudes at least in part through the top surface opening.

3. The tire changing machine according to claim 2, wherein:
the roller assembly, in the inactive position, does not protrude through the top surface opening.

4. The tire changing machine according to claim 1, wherein:
the lifting assembly is movable between a lowered position and a raised position;
the roller assembly is in a deployed position when the lifting assembly is in the lowered position; and
the roller assembly is in an inactive position when the lifting assembly is in the raised position.

5. The tire changing machine according to claim 1, wherein:
the roller assembly further comprises:
a roller configured to engage a tire surface of the wheel assembly; and
a base configured to support the roller when the roller is engaged to the tire surface.

6. The tire changing machine according to claim 5, wherein:
the lifting assembly is movable between a lowered position and a raised position;
the roller assembly is movable between a deployed position and an inactive position;
the roller assembly is in the deployed position when the lifting assembly is in the lowered position; and
the roller assembly is in the inactive position when the lifting assembly is in the raised position.

7. The tire changing machine according to claim 6, wherein:
the support platform further comprises a top surface opening at the roller assembly; and
when the roller assembly is in the deployed position, the roller protrudes at least in part through the top surface opening and the base is configured to engage a ground surface.

8. The tire changing machine according to claim 6, wherein:
the support platform further comprises a top surface opening at the roller assembly; and
when the roller assembly is in the inactive position, the roller does not protrude through the top surface opening.

9. The tire changing machine according to claim 1, wherein:
the support platform further comprises a sloped surface configured to engage a tire surface of the wheel assembly.

10. The tire changing machine according to claim 1, wherein:
the lifting assembly is attached to the frame within an operational range of the bead breaker assembly.

11. The tire changing machine according to claim 1, wherein:
the roller assembly is rotatably coupled to the support platform.

12. The tire changing machine according to claim 5, wherein:
the base further comprises a wheel, a shock absorbing material, or both.

13. A method of operating a tire changing machine, comprising:
providing the tire changing machine, comprising:
a frame;
a rotatable turntable configured to retain a wheel assembly;
a bead breaker assembly attached to a side of the frame and configured to engage the wheel assembly; and
a lifting assembly movably attached to the frame and configured to raise the wheel assembly, the lifting assembly comprising:
a support platform; and
a roller assembly coupled to the support platform;
loading the wheel assembly onto the support platform of the lifting assembly provided in a lowered position;
separating, with the bead breaker assembly, a tire bead of the wheel assembly from a rim of the wheel assembly;
raising the lifting assembly from the lowered position to a raised position;
transferring the wheel assembly from the lifting assembly in the raised position to the rotatable turntable; and
removing, at the rotatable turntable, a tire of the wheel assembly from the rim of the wheel assembly.

14. The method according to claim 13, wherein loading the wheel assembly onto the support platform further comprises:
rolling the wheel assembly onto the support platform via a sloped surface of the support platform; and
engaging the roller assembly with the wheel assembly.

15. The method according to claim 13, wherein separating the tire bead of the wheel assembly from the rim of the wheel assembly further comprises:
rotatably engaging the wheel assembly against the roller assembly.

16. The method according to claim 13, wherein loading the wheel assembly onto the support platform of the lifting assembly provided in the lowered position further comprises:
contacting a ground surface with a base of the support platform;
wherein a roller of the roller assembly protrudes at least in part through a top surface opening of the support platform.

17. The method according to claim 16, wherein:
when raising the lifting assembly from the lowered position to the raised position, the roller retracts through the top surface opening and does not protrude through the top surface opening.

18. The method according to claim 17, wherein:
the roller and the base rotate about a roller assembly axis, the roller assembly axis being parallel to a longitudinal axis of the roller.

19. The method according to claim 17, wherein:
the roller and the base translate relative to the support platform.

20. The method according to claim 14, wherein:
engaging the roller assembly with the wheel assembly causes the roller assembly to contact an edge of a top surface opening.
